(19) United States
(12) Patent Application Publication
(10) Pub. No.: US 2006/0108883 A1
(43) Pub. Date: May 25, 2006

(54) Motor

(75) Inventors: Dung-Chang Yeh, Taoyuan Hsien (TW); Yung-Ping Lin, Taoyuan Hsien (TW); Yong Duan, Taoyuan Hsien (TW); Yi-Liang Gong, Taoyuan Hsien (TW); Jian-Jun You, Taoyuan Hsien (TW); Gang Tong, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/280,360

(22) Filed: Nov. 17, 2005

(30) Foreign Application Priority Data
Nov. 25, 2004 (CN) 2004100974560

(51) Int. Cl. H02K 5/10; H02K 5/12

(52) U.S. Cl. 310/85

(57) ABSTRACT

A motor with an oil seal. The oil seal includes a first storage wall disposed in a position corresponding to a recess of a shaft. The oil seal receives lubricant and prevents leakage of the lubricant, enhancing self-lubrication of the motor. A bottom storage tank with a specific sloped surface is provided in the motor. During rotation of the shaft, the bottom storage tank increases usage of the lubricant, thereby enhancing self-lubrication of the motor.

### BACKGROUND

The invention relates to a motor and in particular to a motor providing self-lubrication function.

Motors, which have a simplified structure and low cost, are widely used to serve as power sources. For example, a motor can be employed in a fan, a compressor, or other devices requiring mechanical operation.

A conventional motor with self-lubricating function can have a long lifespan. As shown in FIG. 1, a motor 1, such as a fan motor, comprises a base 10, a rotor 12, multiple blades 18, and a driving device 16. The base 10 comprises an axial hole 101 in which a bearing 13 is disposed. The rotor 12 is connected to a shaft 14. The shaft 14 fits in the bearing 13. The driving device 16 is located between the rotor 12 and the base 10 and comprises a coil 161 and a magnet 162. The coil 161 is above the base 10 while the magnet 162 is on the rotor 12 and corresponds to the coil 161. The coil 161 and magnet 162 are not limited to the aforementioned positions. Namely, the positions of the coil 161 and magnet 162 can be exchanged to provide the same operation. When the coil 161 is loaded with electric currents, a magnetic field induced by the coil 161 interacts with the magnet 162 to turn the rotor 12. The rotor 12 rotates with respect to the base 10 by means of the shaft 14. The blades 18 rotate with rotor 12, providing functions of heat dissipation. Further, the base 10 can be connected to an outer frame 19 to improve the flow field generated by rotation of the blades 18. The heat dissipation performance of the motor 1 can thus be enhanced. Moreover, to enable free rotation of the shaft 14 with respect to the bearing 13 and to prolong the lifespan of the shaft 14 and bearing 13, lubricant is filled between the shaft 14 and the bearing 13, reducing friction therebetween. Additionally, the base 10 comprises a storage tank 100 disposed near one end of the shaft 14. Please refer FIG. 1. The storage tank 100 is often closed and receives the lubricant overflowing from the connection between the bearing 13 and the shaft 14.

Accordingly, when the shaft 14 rotates with respect to the bearing 13, the amount of lubricant carried by the shaft 14 is quite limited. The lubricant is carried by using pumping effect provided by the bearing 13 in chief. The lubricant in the internal grooves of the bearing 13 is drawn to the interface of the shaft 14 and bearing 13, providing lubrication therebetween. Specifically, a portion of the lubricant returns to the internal grooves of the bearing 13. Another portion of the lubricant vaporizes due to a high temperature resulting from the friction between the shaft 14 and the bearing 13. Yet another portion of the lubricant spreads out from the interface of the shaft 14 and bearing 13 and is received in the storage tank 100. Furthermore, after the motor 1 operates for a long time, most of the lubricant is received in the storage tank 100, this portion of lubricant received in the storage tank 100 cannot re-enter the bearing 13. The lubrication effect between the shaft 14 and the bearing 13 is thus decreased. Moreover, when the shaft 14 rotates with respect to the bearing 13, the lubricant may be drawn upward to the exterior of the shaft 14 and bearing 13. At this point, the lubricant is lost and may be spread to the driving device 16, causing damage to the driving device 16.

### SUMMARY

The invention provides a motor having an oil seal. The oil seal receives and prevents leakage of lubricant, enhancing self-lubrication of the motor.

The invention provides a motor having a bottom storage tank with a specific sloped surface. The bottom storage tank can increase usage of the lubricant, thereby enhancing self-lubrication of the motor.

Accordingly, an exemplary embodiment of the invention provides a motor comprising a base, a bearing, an oil seal, a rotor, and a driving device. The bearing is disposed in the base. Preferably, the bearing is disposed in an axial hole of the base. The oil seal is disposed in the base. The rotor comprises a shaft sequentially penetrating the oil seal and bearing. Lubricant is filled between the shaft and the bearing, providing lubrication during rotation of the rotor. The oil seal comprises a first storage wall disposed in a position corresponding to a recess of the shaft. The driving device is disposed between the rotor and the base to drive the rotor with respect to the base.

In some embodiments of the motor, the first storage wall is extended from the oil seal. A first storage tank is disposed between the inner surface of the first storage wall and the bearing to receive lubricant overflowing from the connection between the shaft and the bearing. The first storage wall is bent after extending from the oil seal to the shaft, and the end of the first storage wall faces the base.

In some embodiments of the motor, the outer surface of the first storage wall is in the recess of the shaft. A first gap exists between the outer surface of the first storage wall and the recess of the shaft.

In some embodiments of the motor, the rotor further comprises a second storage wall disposed on the connection between the rotor and the shaft. A second storage tank is disposed between the second storage wall and the shaft to receive lubricant overflowing from the first gap.

In some embodiments of the motor, the oil seal further comprises a fixing portion, and the fixing portion fixes the oil seal to the base.

In some embodiments of the motor, the oil seal further comprises an extending portion. A second gap exists between the extending portion and the rotor to dissipate surplus lubricant.

In some embodiments of the motor, the motor can be a fan motor comprising a plurality of blades connected to the exterior of the rotor. The blades rotate when the motor operates.

In some embodiments of the motor, the motor further comprises an outer frame connected to the base and covering the blades.

In some embodiments of the motor, the driving device further comprises a coil and a magnet corresponding to the coil. The coil and magnet are respectively disposed on the base and rotor. The motor can operate when the coil is loaded with electric currents.

In some embodiments of the motor, the motor further comprises a bottom storage tank disposed on one end of the shaft to receive the lubricant. The bottom storage tank comprises a sloped surface enclosing the shaft.

In some embodiments of the motor, the sloped surface comprises a curvedly extended sloped surface or a radially extended sloded surface.

In some embodiments of the motor, the bottom storage tank and base are integrally formed.

In some embodiments of the motor, the bottom storage tank is connected to the end of the shaft to rotate with the shaft.

### DESCRIPTION OF THE DRAWINGS

The invention can be more fully understood by reading the subsequent detailed description and examples with references made to the accompanying drawings, wherein:

FIG. 1 is a schematic cross section of a conventional fan motor;

FIG. 2 is a schematic cross section of the fan motor of the invention;

FIG. 3 is a schematic perspective view of the oil seal of the fan motor of the invention;

FIG. 4 is a partial enlarged view of FIG. 2;

FIG. 5 is a schematic perspective view of a curvedly extended sloped surface of the bottom storage tank of the motor of the invention; and

FIG. 6 is a schematic perspective view of a radially extended sloped surface of the bottom storage tank of the motor of the invention.

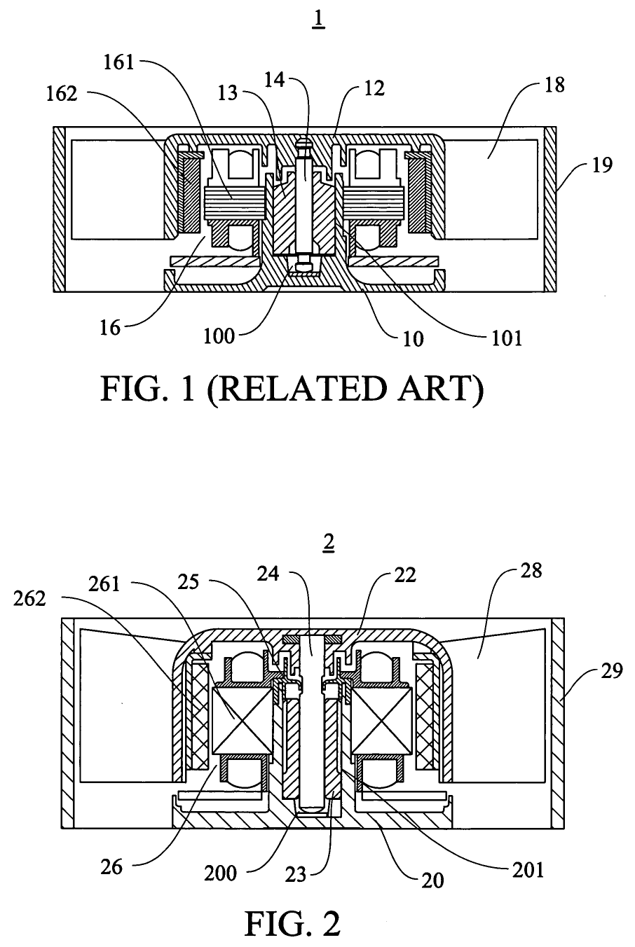

### DETAILED DESCRIPTION

Referring to FIG. 2, the motor may be a fan motor 2 comprising a base 20, a rotor 22, a plurality of blades 28, and a driving device 26. The driving device 26 comprises a coil 261 and a magnet 262 corresponding to the coil 261. The coil 261 and magnet 262 are disposed on the base 20 and rotor 22, respectively. The fan motor 2 further comprises an oil seal 25 disposed in the upper portion of an axial hole 201 of the base 20. A shaft 24 sequentially penetrates the oil seal 25 and bearing 23. The rotor 22 can rotate with respect to the base 20 by means of the shaft 24. The blades 28 can rotate with the rotor 22, thereby providing a heat dissipation function. Moreover, the base 20 is connected to an outer frame 29 to improve the flow field generated by rotation of the blades 28. Performance of heat dissipation of the fan motor 2 is thus enhanced.

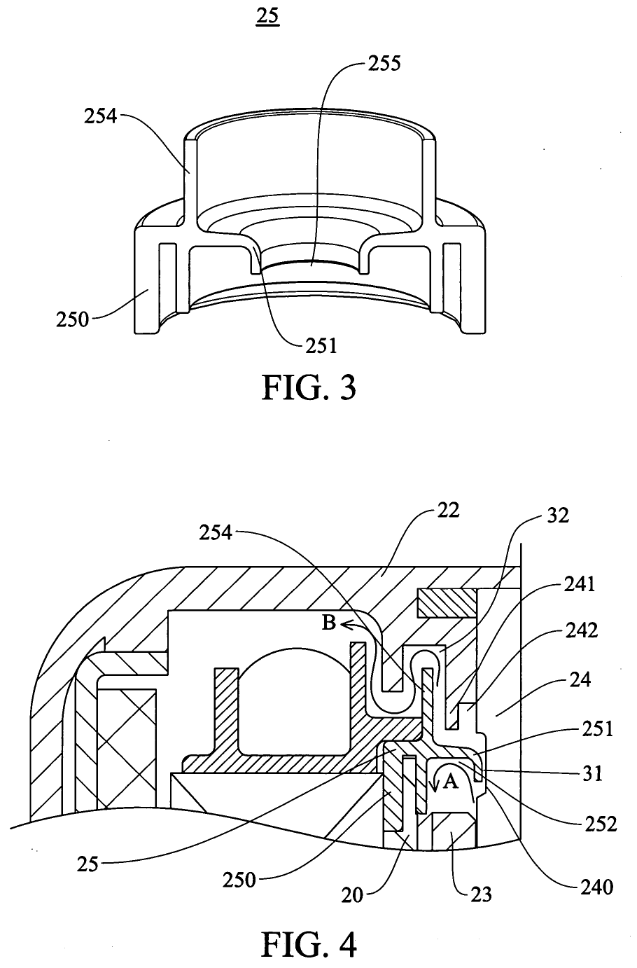

Referring to FIG. 3 and FIG. 4, the oil seal 25 is annular and comprises a first storage wall 251, a fixing portion 250, and an extending portion 254. The oil seal 25 further comprises a through hole 255 through which the shaft 24 passes. The fixing portion 250 fixes the oil seal 25 to the upper portion of the axial hole 201 of the base 20. As shown in FIG. 4, the first storage wall 251 of the oil seal 25 is bent after extending from the oil seal 25 to the shaft 24, and the end of the first storage wall 251 faces the base 20. A first storage tank 252 is disposed between the inner surface of the first storage wall 251 and the bearing 23 to receive the lubricant overflowing from the connection between the shaft 24 and the bearing 23. Additionally, the first storage wall 251 is disposed in a position corresponding to a recess 240 of the shaft 240. Namely, the outside surface of the first storage wall 251 is extended in the recess 240. When the lubricant overflows from the connection between the shaft 24 and the bearing 23, most of the lubricant is guided into the first storage tank 252 by the first storage wall 251. The lubricant then re-enters the connection between the shaft 24 and the bearing 23, as indicated by arrow A in FIG. 4. Accordingly, loss of the lubricant can be prevented and self-lubrication of the fan motor 2 is thus not adversely affected. Moreover, a first gap 31 exists between the outer surface of the first storage wall 251 of the oil seal 25 and the recess 240 of the shaft 24. The lubricant which is not received by the first storage tank 252 overflows via the first gap 31. The rotor 22 further comprises a second storage wall 241 disposed near the connection between the rotor 22 and the shaft 24. A second storage tank 242 is disposed between the second storage wall 241 and the shaft 24 to receive the lubricant overflowing from the first gap 31. When the amount of the lubricant in the first storage tank 252 or between the shaft 24 and the bearing 23 is insufficient, the lubricant received by the second storage tank 242 can be fed back to the connection between the shaft 24 and the bearing 23, to again provide self-lubrication. Additionally, a second gap 32 exists between the extending portion 254 and the rotor 22. Since the second gap 32 has a zigzag structure, unnecessary dissipation of the lubricant, as indicated by arrow B in FIG. 4, can be retarded.

Because of the structures of the oil seal 25, recess 240 of the shaft 24, and rotor 22, most of the lubricant can be retrieved. Namely, dissipation of the lubricant can be reduced and malfunctioning of the self-lubrication of the fan motor 2 can be prevented.

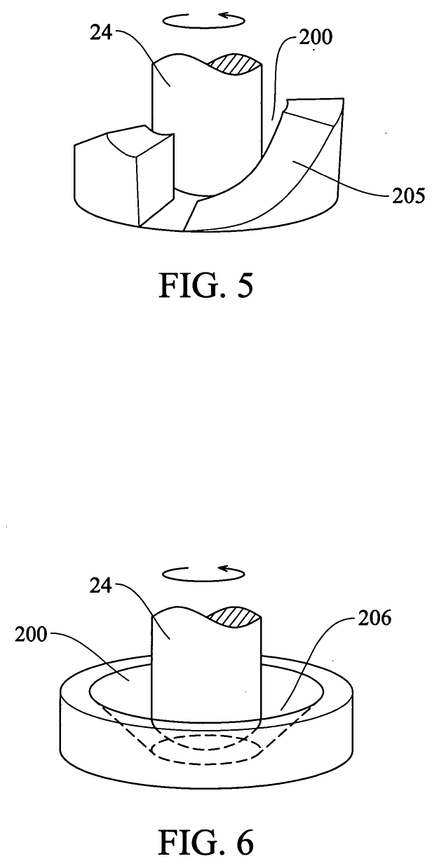

As shown in FIG. 2, the base 20 of the fan motor 2 further comprises a bottom storage tank 200 disposed on one end of the shaft 24 to receive the lubricant. To enhance retrieval usage of the lubricant, the bottom storage tank 200 comprises a sloped surface. When the shaft 24 rotates, the lubricant can be drawn up by the sloped surface and enter the connection between the shaft 24 and the bearing 23, providing lubrication to the fan motor 2. As shown in FIG. 5, the sloped surface of the bottom storage tank 200 may be a curvedly extended sloped surface 205. Namely, the curvedly extended sloped surface 205 is a sloped surface gradually ascending in a curved manner. When the shaft 24 rotates, the lubricant can be drawn by the curvedly extended sloped surface 205 and rotate around the shaft 24. The lubricant can ascend along the curvedly extended sloped surface 205 to the connection between the shaft 24 and the bearing 23. Moreover, as shown in FIG. 6, the sloped surface of the bottom storage tank 200 may be a radially extended sloped surface 206. Namely, the radially extended sloped surface 206 is a sloped surface gradually and outward ascending from the shaft 24. When the shaft 24 rotates, the lubricant can be drawn by the radially extended sloped surface 206 and rotate around the shaft 24. A centrifugal force is thus generated in the lubricant. The lubricant can ascend along the radially extended sloped surface 206 to the connection between the shaft 24 and the bearing 23, providing lubrication to the fan motor 2. Additionally, the curvedly extended sloped surface 205 or radially extended sloped surface 206 can be integrally formed with the base 20, thereby reducing manufacturing costs of the fan motor 2.

The base 20 has the aforementioned sloped surface. When the shaft 24 rotates, the lubricant is drawn up by viscosity thereof along the sloped surface. The lubricant then enters the connection between the shaft 24 and the bearing 23. In another aspect, the sloped surface (curvedly extended sloped surface 205 or radially extended sloped surface 206) may be formed with the shaft 24. Thus, the sloped surface can rotate with the shaft 24. Namely, the shaft 24 and sloped surface (curvedly extended sloped surface 205 or radially extended sloped surface 206) rotate synchronously. The lubricant can also ascend to the connection between the shaft 24 and the bearing 23, providing lubrication to the fan motor 2.

Accordingly, the lubricant in the bottom storage tank 200 can be fully utilized. Thus, usage of the lubricant is increased, self-lubrication of the fan motor 2 is enhanced, and the lifespan of the fan motor 2 is prolonged.

Additionally, the aforementioned structure of this embodiment is not limited to a fan motor. Namely, the aforementioned structure can also be employed in other motors requiring self-lubrication.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motor, comprising:
a base;
a bearing disposed in the base;
an oil seal disposed in the base;
a rotor comprising a shaft penetrating the oil seal and bearing, wherein a lubricant is filled between the shaft and the bearing, and the oil seal comprises a first storage wall disposed in a position corresponding to a recess of the shaft; and
a driving device disposed between the rotor and the base to drive the rotor.

2. The motor as claimed in claim 1, wherein the first storage wall is extended from the oil seal, and a first storage tank is disposed between an inner surface of the first storage wall and the bearing.

3. The motor as claimed in claim 2, wherein the first storage wall is bent after extending from the oil seal to the shaft, and the end of the first storage wall faces the base.

4. The motor as claimed in claim 2, wherein an outer surface of the first storage wall is in the recess of the shaft, and a first gap exists between the outer surface of the first storage wall and the recess of the shaft.

5. The motor as claimed in claim 4, wherein the rotor further comprises a second storage wall disposed on the connection between the rotor and the shaft, and a second storage tank is disposed between the second storage wall and the shaft.

6. The motor as claimed in claim 1, wherein the oil seal further comprises a fixing portion for fixing the oil seal onto the base.

7. The motor as claimed in claim 1, wherein the oil seal further comprises an extending portion, and a second gap exists between the extending portion and the rotor.

8. The motor as claimed in claim 1, further comprising a bottom storage tank disposed on one end of the shaft, wherein the bottom storage tank comprises a sloped surface enclosing the shaft.

9. The motor as claimed in claim 8, wherein the sloped surface comprises a curvedly extended sloped surface or a radially extended sloped surface.

10. The motor as claimed in claim 8, wherein the bottom storage tank and base are integrally formed.

11. The motor as claimed in claim 8, wherein the bottom storage tank is connected to the end of the shaft to rotate with the shaft.

12. A motor, comprising:
a base;
a bearing disposed in the base;
a rotor comprising a shaft penetrating the bearing, wherein a lubricant is filled between the shaft and the bearing;
a bottom storage tank disposed on one end of the shaft to receive the lubricant, wherein the bottom storage tank comprises a sloped surface enclosing the shaft; and
a driving device disposed between the rotor and the base to drive the rotor.

13. The motor as claimed in claim 12, wherein the sloped surface comprises a curvedly extended sloped surface or a radially extended sloped surface.

14. The motor as claimed in claim 12, wherein the bottom storage tank and base are integrally formed.

15. The motor as claimed in claim 12, wherein the bottom storage tank is connected to the end of the shaft to rotate with the shaft.

16. The motor as claimed in claim 12, further comprising an oil seal disposed in the base, wherein the shaft penetrates the oil seal and bearing, and the oil seal comprises a first storage wall disposed in a position corresponding to a recess of the shaft.

17. The motor as claimed in claim 16, wherein the first storage wall is extended from the oil seal, and a first storage tank is disposed between an inner surface of the first storage wall and the bearing.

18. The motor as claimed in claim 16, wherein the first storage wall is bent after extending from the oil seal to the shaft, and the end of the first storage wall faces the base.

19. The motor as claimed in claim 17, wherein an outer surface of the first storage wall is in the recess of the shaft, and a first gap exists between the outer surface of the first storage wall and the recess of the shaft.

20. The motor as claimed in claim 19, wherein the rotor further comprises a second storage wall disposed on the connection between the rotor and the shaft, and a second storage tank is disposed between the second storage wall and the shaft.

21. The motor as claimed in claim 16, wherein the oil seal further comprises a fixing portion for fixing the oil seal to the base.

22. The motor as claimed in claim 16, wherein the oil seal further comprises an extending portion, and a second gap exists between the extending portion and the rotor.
